(19) United States
(12) Patent Application Publication
(10) Pub. No.: US 2008/0095624 A1
(43) Pub. Date: Apr. 24, 2008

(54) LIGHTNING PROTECTION OF WIND TURBINES

(76) Inventor: Bastian Lewke, Munich (DE)

Correspondence Address: GENERAL ELECTRIC CO.;GLOBAL PATENT OPERATION, 187 Danbury Road, Suite 204, Wilton, CT, 06897-4122, US

(21) Appl. No.: 11/550,942

(22) Filed: Oct. 19, 2006

(51) Int. Cl. B64C 27/00

(52) U.S. Cl. 416/146 R

(57) ABSTRACT

A rotor blade for a wind turbine is described. The rotor blade includes a lightning protection system. Thereby, the rotor blade body includes a non-conductive material, at least one receptor adapted to be a location for lightning impact, an insulated down conductor element within the rotor blade body, wherein the insulated down conductor includes: a down conductor, wherein the down conductor and the at least one receptor being connected, and a dielectric sheet covering the down conductor as an insulation.

### BACKGROUND OF THE INVENTION

The present invention relates to lightning protection of wind turbines. More particularly, the invention relates to lightning protection of wind turbines and lightning protecting of rotor blades of wind turbines. Specifically, the invention relates to a rotor blade, a lightning protection system, and a method of manufacturing a rotor blade.

Damage to wind turbines due to lightning strikes has been recognized as an increasing problem. The influence of lightning faults on the reliability of wind turbines and wind turbine farms may become a concern as the capacity of wind turbines increases. This is particularly the case when several large wind turbines are operated together in wind farm installations because the potential loss of multiple large production units due to one lightning strike may be significant. Unlike other electrical installations such as overhead lines and power plants, it is more difficult for wind turbines to provide protective conductors that can be arranged around or above the wind turbine. This is due to the physical size and nature of wind turbines. Wind turbines typically have two or three blades with a diameter of several tens of meters up to 100 m or more. The rotor rotates high above the ground. In addition, there is extensive use of insulating composite materials, such as glass fiber reinforced plastic, as load-carrying parts. Aerodynamic considerations and consideration of the fast rotating blades also have to be taken into account for a lightning protection system.

### BRIEF DESCRIPTION OF THE INVENTION

In view of the above, according to one embodiment, a rotor blade for a wind turbine is provided. The rotor blade includes a rotor blade body, at least one receptor adapted to be a location for lightning impact, and an insulated down conductor element within the rotor blade body. The insulated down conductor includes a down conductor, wherein the down conductor and the at least one receptor are connected, and a dielectric sheet covering the down conductor as an insulation with a dielectric strength of at least 10 kV/mm.

Further embodiments, aspects, advantages and features are apparent from the dependent claims, the description and the accompanying drawings.

According to yet another embodiment, a lightning protection system for a wind turbine is provided. The system includes a rotor blade body, at least one lightning attachment point comprising a conductive material at the outer surface of the rotor blade body, a down conductor, wherein the down conductor and the at least one lightning attachment point being electrically connected, and an insulation sheet being directly applied onto the down conductor and being adapted to reduce the probability for a lightning strike to attach to a point at the down conductor or a point at the rotor blade other than the at least one lightning attachment point.

Further embodiments refer to wind turbines including rotor blades and lightning protection systems described herein.

According to another embodiment, a method for manufacturing a rotor blade for a wind turbine is described. The method includes: insulating a down conductor with a dielectric sheet providing a dielectric strength of a least 10 kV/mm, mounting the insulated down conductor with a rotor blade body, and connecting at least one receptor adapted to be a location for lightning attachment with the down conductor.

### BRIEF DESCRIPTION OF THE DRAWINGS

A full and enabling disclosure of the present invention including the best mode thereof, to one of ordinary skill in the art is set forth more particularly in the remainder of the specification, including reference to the accompanying figures wherein:

FIG. 1 shows a schematic drawing illustrating a wind turbine including a rotor blade lightning protection system according to embodiments described herein;

FIG. 2 shows a schematic drawing illustrating a part of a rotor blade including receptors and a down conductor in a rotor blade according to embodiments described herein;

FIGS. 3a and 3b show schematic drawings illustrating down conductor elements within a rotor blade according to embodiments described herein.

FIG. 4 shows a drawings illustrating another down conductor element within a rotor blade according to embodiments described herein; and

FIG. 5 shows a schematic drawing illustrating an equivalent circuit of a lightning situation at a rotor blade.

### DETAILED DESCRIPTION OF THE INVENTION

Reference will now be made in detail to the various embodiments of the invention, one or more examples of which are illustrated in the figures. Each example is provided by way of explanation of the invention and is not meant as a limitation of the invention. For example, features illustrated or described as part of one embodiment can be used on or in conjunction with other embodiments to yield yet a further embodiment. It is intended that the present invention includes such modifications and variations.

Modern wind turbine blades are structures manufactured of various materials, such as glass reinforced plastic (GRP), wood, wood laminate and carbon reinforced plastic (CRP). Parts and components such as mounting flanges, weights, bearings, wires, and electrical wiring are made of metal. Particularly, for blades constructed entirely from non-conducting materials, lightning attachment points, that is receptors, are mostly found close to the tip or distributed over the blade.

The generic problem of lightning protection of wind turbine blades is to conduct the lightning current safely from the attachment point to the hub. Therefore, the system has to be fully integrated into the different parts of the wind turbines to ensure that all parts likely to be lightning attachment points are able to withstand the impact of the lightning strike.

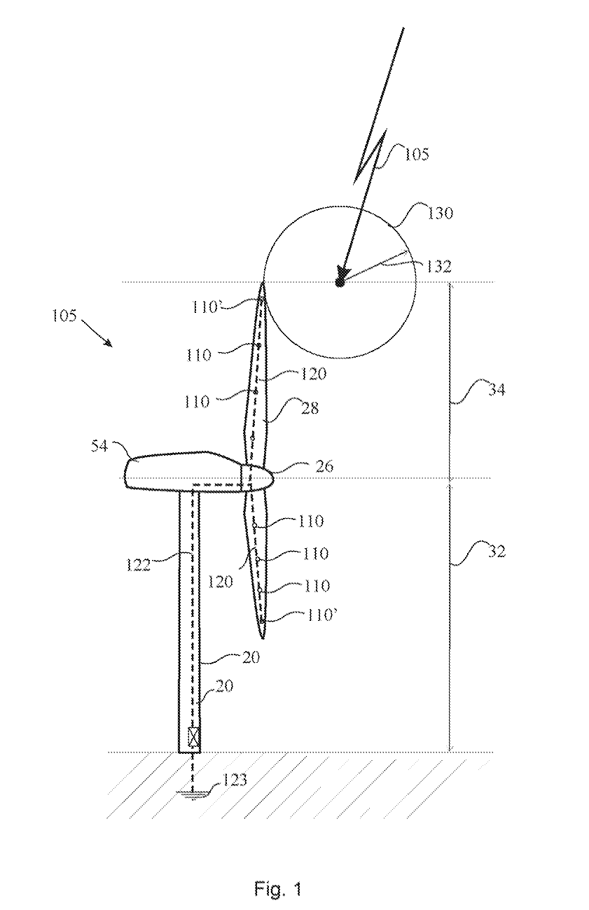

FIG. 1 illustrates a first embodiment of a wind turbine 100. On top of the tower 20 nacelle 22 is located. The hub 26 is rotateably mounted to the nacelle 22. The hub is further connected to the rotor blades 28. The highest point of incidents of lightning 105 is given by the height 32 of the tower and the length 34 of the blade, which is the radius of the rotor, respectively. In order to be within a predetermined lightning protection safety class, lightning which comes closer as a predetermined distance to a part of the wind turbine needs to be prevented from damaging the installation. The distance of the lightning 105 from the wind turbine distinguishes the different lightning protection safety classes. A general method is the rolling sphere method to determine lightning protection classes. Thereby, a sphere 130 having a radius 132 is virtually rolled over each part of the system to be protected. The area at risk of lightning impact is defined as the sphere with the center being the leader channel of the lightning. The surface of the sphere 130 is considered to be those points from which a discharge may occur.

Different radii are given for different lightning protection classes, e.g. 20 m for class I. For each surface location a lightning strike has a certain probability. The smaller the radius, the more likely a lightning strike will occur. Protection is provided for each possible position of the sphere 130 with radius 132 rolled over the wind turbine.

For example, in order to be lightning protection safety class I, lightning must be able to come as close as the sphere 130 with the radius of 20 m and the wind turbine needs to be protected from lightning with a leader channel coming within a distance such that sphere of points with a possible discharge does not touch the installation. In other words, it is desirable to have a lightning protection system for the wind turbine and components thereof so that the sphere with a radius which corresponds to a distance that would damage the wind turbine or components thereof does not touch the surface of the wind turbine.

Within an embodiment illustrated in FIG. 1, receptors 110, 110′ are located on the rotor blades 28. The receptors are connected to down conductor 120 within the blades. Further, an electrical connection is established via the hub 26 and the conductor 122 such that currents from lightning striking the receptors could flow through down conductor 120, conductor 122, which is grounded as indicated by reference 123.

Thereby, a lightning protection of the blades is established by providing the receptors as desired locations of incidents of lightning and providing conductors to discharge the charge of the lightning. The principle of this protection system is to provide a preferred path for the lightning.

Thus, the lightning protection system may have discrete lightning receptors placed at the blade tip. From the receptors at the tip, an internal down conductor system leads the lightning current to the blade root. This can for example be applied for blades of a length up to 20 m. According to another embodiment, particularly longer blades are equipped with several receptors distributed over the blade. The receptors penetrating the surface may, according to one embodiment, be placed in such a way that the likelihood of lightning attaching to the unprotected part of the surface is reduced. The spacing of discrete receptors may, according to another embodiment, for example be a spacing where the flashover voltage along the blade surface is smaller than the breakdown voltage of the blade skin. As an example, solid conductors may according to one embodiment be placed on the surface with spacing ranging from 30 cm to 60 cm.

However, locations at which lightning strikes the wind turbine or components thereof are given by a local electrical field. Damage to wind turbines, which have been previously reported, showed that in some instances lightning strikes down conductor directly, particularly to the trailing edge of rotor blade. Lightning strikes to non-conducting blades may at least partly be explained by the fact that water makes blades more conductive. Another factor can be that blades may simply be in the way of lightning striking the wind turbine. In addition, it is known that discharges develop along a surface more easily than through air.

When lightning strikes the down conductor directly through a nonconductive part of the rotor blade, for example, the trailing edge of blade, damage to the GRP of the rotor blade may occur due to surface carbonization of the glass fibers, punctures and delamination. This damage can deteriorate the functionality and/or lifetime of the rotor blade and further may provide a preferred path for a second and further strike of lightning.

Severe damage to wind turbine blades is caused when lightning forms arcs inside the blade. The arcs may form in the air filled cavities inside the blade or along the inner surfaces. The pressure shock wave caused by such internal arcs may destroy the blade surface skins. Internal arcs often form between the lightning attachment point at the tip of the blade and some conducting component internal to the blade. Another type of damage occurs when the lightning current or part of it is conducted in or between layers of composite materials, presumably because such layers hold some moisture.

According to the embodiments described herein, the electrical field strength around the down conductor 120, which determines whether lightning strikes the down conductor directly, is reduced by providing an insulation sheet around the down conductor.

Thereby, the down conductor element is provided in form of an insulated cable. According to one embodiment, this insulation is provided particularly in regions of the rotor blade in which it is most likely that lightning might strike the rotor blade. This region can for example be the outer (tip) part of the rotor blade 28. It is understood that covering the down conductor 120 with an insulation sheet means that essentially the entire down conductor is covered except for those parts, for example, at which connections to the receptors are present. According to another embodiment, the connections to the receptors can also be insulated with an insulation material.

The insulation sheet around the down conductor reduces the electrical field strength around the down conductor and, therefore, may avoid electrical breakdown. Further, according to another embodiment, the insulation around the down conductor may homogenize the electrical field around the down conductor. According to glass-fiber web bonding, which has been commonly used, the electrical field could not be controlled to be homogenous. According to embodiments described herein, the insulation sheet around the down conductor enables a control of a homogenous electrical field.

A down conductor system may have sufficient cross-section to be able to withstand a direct lightning strike and conduct the full lightning current. According to one embodiment, the minimum cross-section for aluminum may for example be 50 mm². The down conductor system is connected to receptors on the blade. These conductors mounted on the blade surface may deteriorate the aerodynamics of the blade or generate undesirable noise. For lightning conductors embedded in the blade, wires or brads of, for example, either aluminum or copper can be used. Lightning down conductors may be placed inside the blade. Metallic fixtures for the conductor penetrate the blade surface and serve as discrete lightning receptors. The materials used for lightning protection of wind turbine blades shall be able to withstand the electric, thermal and electrodynamic stresses imposed by the lightning current.

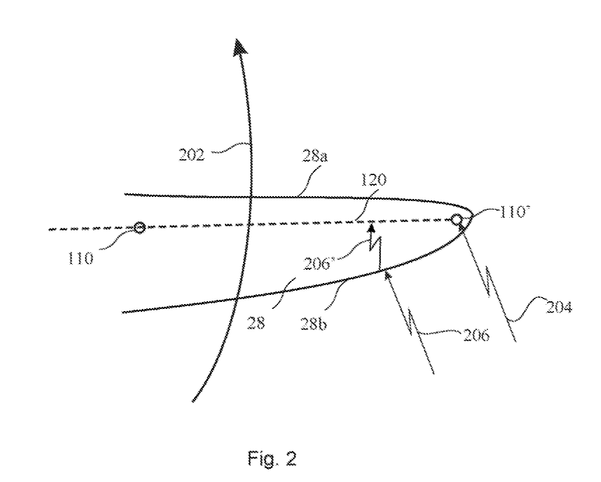

FIG. 2 illustrates another embodiment. In FIG. 2 a rotor blade 28 is shown. The rotating direction is illustrated by arrow 202. The rotor blade 28 has a leading edge 28a and trailing edge 28b. The rotor blade 28 includes receptor 110′ at the tip of the rotor blade and receptor 110 within the rotor blade. The receptors 110, 110′ are connected by down conductor 120.

For commonly used lightning protection systems the following situations have been observed. On the one hand, there are lightning strikes 204 to one of the receptors and the charge is discharged via the down conduct or 120. On the other hand, there might also be lightning strikes 206, 206′ which penetrate the rotor blade 28, wherein the down conductor 120 is struck directly by lightning. Thereby, the above-mentioned damages occur.

An insulation sheet around the down conductor, according to the embodiments described herein, the electrical field strength around the down conductor 120, which determines whether lightning strikes the down conductor directly, is homogenized and reduced by providing an insulation sheet around the down conductor.

The down conductor element may be provided in the form of an insulated cable. The insulation sheet around the down conductor reduces the electrical field strength around the down conductor and may, thereby, avoid electrical breakdown thereto. Further, according to another embodiment, the insulation around the down conductor may homogenize the electrical field around the down conductor. According to glass-fiber web bonding which has been commonly used, the electrical field could not be controlled to be homogenous. According to embodiments described herein, the insulation sheet around the down conductor enables a control of a homogenous electrical field.

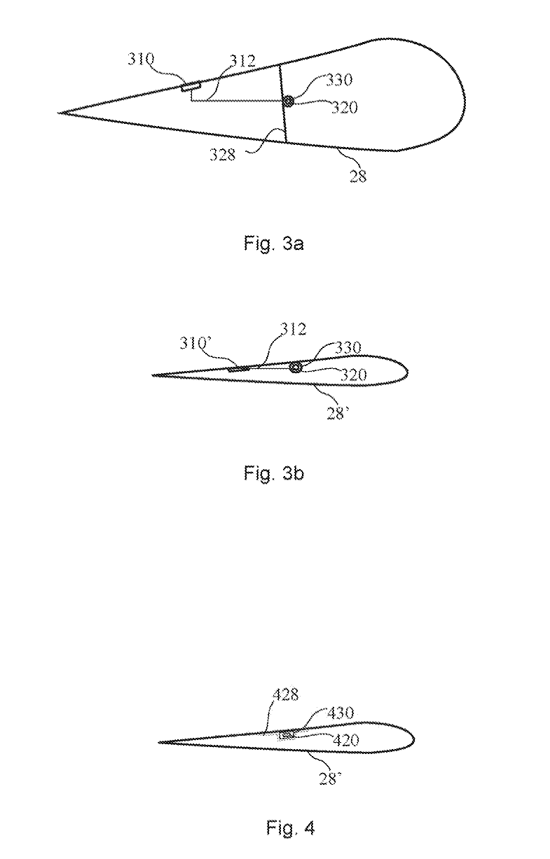

According to an embodiment which is illustrated in FIGS. 3a and 3b, the down conductor element including down conductor 320 and insulator 330 is provided. The insulation reduces the risk of lightning strikes directly to the down conductor. Thereby, the desired discharge path along the receptors 310, the conductor 312 to the down conductor, and the down conductor 320 itself has an even higher probability. Accordingly the probability of a lightning strike directly attaching to the down conductor through non-conductive parts of the shell of the rotor blade can be reduced.

FIG. 3a shows a central portion of the rotor blade 28. FIG. 3b shows a tip end portion 28′ of the rotor blade. Within the hollow structure of the rotor blade a reinforcement bar 328 may be provided. According to one embodiment, the down conductor element in the form of an insulated down conductor 320, 330 may be mounted to the reinforcement bar 328. As shown in FIG. 3b, the down conductor element may be guided to one of the inner surfaces of the rotor blade at the tip and portion. Generally, the receptors 310, 310′ are connected to the down conductor with conductors 312.

According to another embodiment, the cross-section of the down conductor 320 is circular or has at least a minimum radius of curvature of above 2 mm. As compared to a rectangular down conductors, a curved down conductor cross-section further decreases the electrical field, which occurs during lightning strike, and thereby further reduces the risk of erroneously attaching lightning strikes. According to a further embodiment, the electric strength of the insulator sheet 330 has at least an electric strength of 50 kV/mm. Typically, according to another embodiment, the electric strength is above 100 kV/mm. The thickness of the insulation may for example be in the range of 0.5 to 5 mm. According to other embodiments, a multilayer dielectric sheet acting as an isolation of the down conductor can be provided.

According to further embodiments, the down conductor may include copper or aluminum as a material for discharge conducting. Depending on the materials, the area of the cross-section of the down conductor may be at least 30 mm², 50 mm², 70 mm², or even higher. Thereby, it has to be considered that depending on the cross-section and the resistivity corresponding therewith, the temperature of the down conductor may be more or less increased when a lightning strike occurs. On a lightning strike a temperature increase of the down conductor of up to 100° C. or more can be expected. This, in combination with the outside temperature, the insulator material may have a resistivity for temperatures of 150° C., 160° C., 180° C., or even higher temperatures. Typically, the temperature resistivity may be a long-term temperature resistivity in order to maintain the durability of the insulation during the entire lifetime of the rotor blade. According to different embodiments, one of the following materials may be used: Ethylene-Chlorinetrifluoreneethylen-Copolymer, Ethylene-Tetrafluoreneethylen-Copolymer, or Polyfluorineethylenepropylene.

According to another embodiment, the down conductor element including the down conductor 320 and the insulation 330 is positioned within the rotor blade 28 such that the down conductor element is essentially located along the neutral axis of the rotor blade. During operation of a wind turbine, the rotor blades experience bending due to the wind forces acting upon them. Generally, independent of whether the rotor blade is pre-biased, there is a neutral axis (neutral fiber) or an area with a minimum compression or tension of the rotor blade. The down conductor element is typically positioned along this area with minimum material compression or material tension. As indicated in FIGS. 3a and 3b, this might at least apply for a central portion of the rotor blade. According to another embodiment, the material of the insulation of the down conductor has a Young's modulus of about 10 kN/mm², 5 kN/mm² or less. Thereby, the elasticity of the rotor blade is hardly affected by providing an insulation 330 for the down conductor.

FIG. 4 illustrates another embodiment. Therein, a tip end portion 28′ of rotor blade is shown. A down conduct 420, which is insulated by the insulation sheet 430, is provided on an inner surface of the rotor blade. For manufacturing reasons, the down conductor has a noncircular shape. This may at least apply for the tip end portion of the rotor blade. The electrical field strength which is increased thereby may be controlled by providing additional insulation. This can be realized, for example, by providing an insulation with an increased electrical strength or by providing a thicker insulation sheet.

Within FIG. 4, the down conductor element is attached to the rotor blade by the glass fiber sheet 428. As described above, within a central portion of the rotor blade, the down conductor may, for example, be located at a reinforcement bar within the rotor blade.

According to another embodiment, the electric strength of the insulator sheet 330 has at least an electric strength of 70 kV/mm. Typically, according to another embodiment, the electric strength is above 120 kV/mm. As described above, a rectangular down conductor might have a thicker insulation, e.g., in the range of 0.5 mm to 8 mm. Yet according to other embodiments, the insulator sheet may be provided as a multilayer dielectric sheets for isolation with improved field control.

As describer with respect to previous embodiments, there may be modifications to establish further embodiments. Accordingly, the down conductor may include copper or aluminum as a material for discharge conducting. Depending on the materials, the area of the cross-section of the down conductor may be at least 30 mm², 50 mm², 70 mm², or even higher. Further, the insulator material may have a resistivity for temperatures of 150° C., 180° C., or even higher temperatures. Typically, the temperature resistivity may be a long-term temperature resistivity in order to maintain the durability of the insulator during the entire lifetime of the rotor blade. According to different embodiments, one of the following materials may be used: Ethylene-Chlorinetrifluoreneethylen-Copolymer, Ethylene-Tetrafluoreneethylen-Copolymer, or Polyfluorineethylenepropylene.

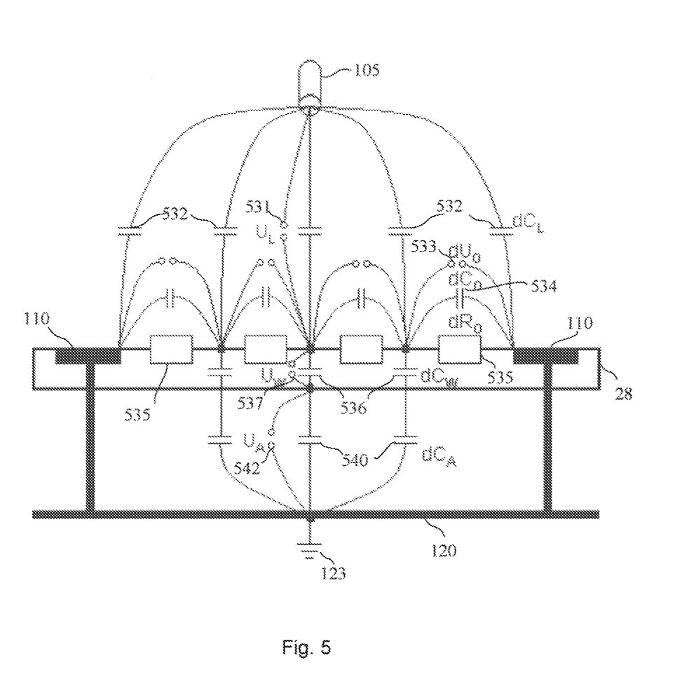

FIG. 5 illustrates an equivalent circuit diagram of a rotor blade in lighting conditions. Generally, lightning can be simulated by a leader channel 530. The leader channel indicates a certain amount of charge per length unit. FIG. 5 further shows receptors 110 integrated in a surface of rotor blade 28. The receptors 110 are connected to down conductor 120. The down conductor is grounded as indicated by reference numeral 123. For a given situation of lightning, that is a given leader channel 530, there are break-through voltages U_{L} (531) and impedance dC_{L}(532) between the leader channel and the rotor blade. The surface of the rotor blade has equivalent elements of break-through voltages dUₒ (532), impedances dCₒ (534) and resistance/impedance dRₒ (535), respectively. These surface properties can be indicated per length units. Thus, there are several length units between the two receptors shown in FIG. 5.

Additionally to the conductors between the receptors 110 and the down conductor 120, which are drawn to be ideal (no resistivity), there are impedances dC_{W} (536) and break-through voltages dU_{W} (537) within the surface of the rotor blade 28. Between the rotor blade surface and the down conductor, there are impedances dC_{A} (540) and break-through voltages dU_{A} (542).

The break-through voltages 531, 537, and 542 are indicated on the direct line between the leader channel 530 and the down conductor. By providing the insulation, as described above, the impedances dC_{A} (540) between the rotor blade surface and the down conductor are increased. The break-through voltages U_{A} (542), which originates together with the potentials 531 and 537 from the leader channel 530, are increased. Thus, the probability of a lightning strike into one of the receptors 110 is increased.

What is claimed is:

1. A rotor blade for a wind turbine comprising:
a rotor blade body;
at least one receptor adapted to be a location for lightning impact;
an insulated down conductor element within the rotor blade body, the insulated down conductor comprises:
a down conductor, wherein the down conductor and the at least one receptor being connected; and
a dielectric sheet covering the down conductor as an insulation with a dielectric strength of at least 10 kV/mm.

2. The rotor blade of claim 1, wherein the down conductor is covered with the dielectric sheet at non-branching off-portions along at least 75% of the length of the rotor blade towards the tip end of the rotor blade.

3. The rotor blade of claim 1, wherein the dielectric strength of the dielectric sheet is at least 50 kV/mm.

4. The rotor blade of claim 1, wherein the down conductor has a curved cross-section with a minimal radius of curvature above 2 mm.

5. The rotor blade of claim 4, wherein the down conductor has a circular cross-section.

6. The rotor blade of claim 1, wherein the down conductor has cross-sectional area of at least 30 mm².

7. The rotor blade of claim 1, wherein the dielectric sheet material has a long-term temperature resistance for temperatures of at least 120° C.

8. The rotor blade of claim 1, wherein the dielectric sheet comprises a material of the group consisting of: Ethylene-Chlorinetrifluoreneethylen-Copolymer, Ethylene-Tetrafluoreneethylen-Copolymer, and Polyfluorineethylenepropylene.

9. The rotor blade of claim 1, wherein the dielectric sheet material has a Young's modulus of about 10 k/N/mm² or less.

10. The rotor blade of claim 1, wherein down conductor is located approximately at the neutral axis of the rotor blade.

11. A wind turbine comprising:
a rotor blade according to claim 1.

12. A lightning protection system for a wind turbine comprising:
a rotor blade body;
at least one lightning attachment point comprising a conductive material at the outer surface of the rotor blade body;
a down conductor, wherein the down conductor and the at least one lightning attachment point being electrically connected; and
an insulation sheet being directly applied onto the down conductor and being adapted to reduce the probability for a lightning strike to attach to a point at the down conductor or a point at the rotor blade other than the one lightning attachment point.

13. The lightning protection system of claim 12, wherein the dielectric strength of the dielectric sheet is at least 100 kV/mm.

14. The lightning protection system of claim 12, wherein the down conductor has a curved cross-section with a minimal radius of curvature above 2 mm.

15. The lightning protection system of claim 12, wherein the down conductor has cross-sectional area of at least 50 mm².

16. The lightning protection system of claim 12, wherein the dielectric sheet material has a long-term temperature resistance to temperatures of at least 120° C.

17. A wind turbine comprising:
a lightning protection system according to claim 12.

18. A method for manufacturing a rotor blade for a wind turbine comprising:
insulating a down conductor with a dielectric sheet providing a dielectric strength of a least 10 kV/mm;
mounting the insulated down conductor with a rotor blade body; and
connecting at least one receptor adapted to be a location for lightning attachment with the down conductor.

19. The method for manufacturing a rotor blade of claim 18, wherein down conductor is insulated along at least 75% of the length of the rotor blade.

20. The method for manufacturing a rotor blade of claim 18, wherein down conductor is mounted approximately at the neutral axis of the rotor blade.
